(19) United States
(12) Patent Application Publication
(10) Pub. No.: US 2026/0072668 A1
(43) Pub. Date: Mar. 12, 2026

(54) SYSTEM AND METHOD FOR PREDICTION-BASED IMAGING OF COMPUTING DEVICES

(71) Applicant: Optum, Inc., Minnetonka, MN (US)

(72) Inventors: Patrick Daniel Barrett, Littleton, CO (US); Kenneth T Lehmann, Joliet, IL (US)

(21) Appl. No.: 18/830,989

(22) Filed: Sep. 11, 2024

(51) Int. Cl. G06F 8/61

(52) U.S. Cl. CPC G06F 8/63

(57) ABSTRACT

Various embodiments of the present disclosure provide methods, apparatus, systems, computing devices, computing entities, and/or the like for receiving pre-imaging data for a plurality of pre-imaged computing devices; generating, using the pre-imaging data, a plurality of data objects that respectively correspond to the plurality of pre-imaged computing devices, wherein a first data object of the plurality of data objects comprises a data construct that describes a first computing device of the plurality of pre-imaged computing devices; receiving a computing device provisioning request comprising one or more hardware specifications and application criteria; determining a computing device from the plurality of pre-imaged computing devices based at least in part on the one or more hardware specifications and the plurality of data objects; generating a custom build instruction identifying the application criteria; and transmitting the custom build instruction to the computing device.

### BACKGROUND

Various embodiments of the present disclosure address technical challenges related to provisioning computing devices and provide solutions to address the shortcomings of existing computer imaging and building processes.

Corporate information technology (IT) organizations may provision computers, such as laptops and desktops, for employees. For example, a corporate IT organization may provision computers on a predetermined schedule or in response to specific events, such as new employee hires or a need to replace damaged computers. A conventional approach for provisioning computers may comprise setting up a computer along with any needed peripherals, establishing an image deployment mechanism, imaging the computer with the image deployment mechanism, and providing the computer to a recipient user. However, each step in the computer provisioning process may be time consuming and contributes to delays in providing the computer to the recipient user.

To mitigate the time it takes to provision computers, pre-built computers that are ready for shipment upon request may be prepared ahead of time. However, pre-built computers carry the risk of remaining in inventory for some time, potentially lacking current security remediations, optimal version levels, or a latest image version. Additionally, preparing a new image incurs unnecessary waste when having to rebuild a computer that has already been constructed. Additionally, the imaging process itself may present additional challenges. For example, an entire suite of applications may be installed on an image, potentially leading to unnecessary licensing costs, electronic storage use, time to install, and/or unnecessary additional processing for applications not universally used. Manually or semi-automatically installing each application in a customized manner may add to the time and complexity of the computer provisioning process.

### BRIEF DESCRIPTION OF THE DRAWINGS

FIG. 1 provides an example overview of an architecture in accordance with some embodiments of the present disclosure.

FIG. 2 provides an example computing entity in accordance with some embodiments of the present disclosure.

FIG. 3 provides an example client computing entity in accordance with some embodiments of the present disclosure.

FIG. 4 is a flowchart diagram of an example process for configuring inventory computing devices in accordance with some embodiments of the present disclosure.

FIG. 5 is a flowchart diagram of an example process for comparing a computing device provisioning request with inventory data objects in accordance with some embodiments of the present disclosure.

FIG. 6 is a flowchart diagram of an example process for maintaining a plurality of pre-imaged inventory computing devices in accordance with some embodiments of the present disclosure.

FIG. 7 is a flowchart diagram of an example process for initiating a custom build operation in accordance with some embodiments of the present disclosure.

FIG. 8 is a flowchart diagram of an example process for provisioning a computing device in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

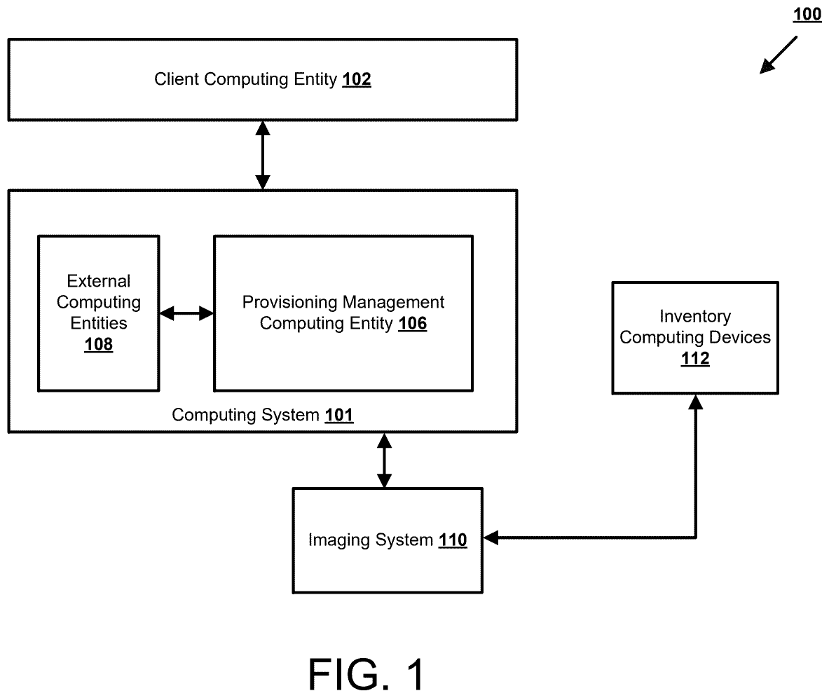

FIG. 1 provides an example overview of an architecture 100 in accordance with some embodiments of the present disclosure. The architecture 100 includes a computing system 101 configured to receive computing device provisioning requests from one or more client computing entity 102, process the computing device provisioning requests by communicating with and querying a database to determine an inventory computing device from among one or more inventory computing devices 112 based on the computing device provisioning requests, provide automated custom build instructions identifying application criteria (for custom build operations to be performed by the imaging system 110 on the inventory computing devices) from the computing device provisioning requests, and generate one or more logistical operation instructions for the inventory computing devices. The example architecture 100 may be used in a plurality of domains and not limited to any specific application as disclosed herewith. The plurality of domains may include banking, legal, healthcare, industrial, manufacturing, education, retail, to name a few.

In accordance with various embodiments of the present disclosure, a predictive machine learning model may be trained to predict inventory demand that are associated with computing devices that may be needed for provisioning. Accordingly, an optimal number of computing devices comprising one or more specific hardware specifications may be at least partially configured (e.g., pre-imaged) in advance for anticipated provisioning needs such that lead times between computing device provisioning requests and when computing devices are provided to recipient users associated with the computing device provisioning requests may be reduced. This technique will lead to improved imaging of computing devices in a manner that anticipates future needs, reduces wasted pre-imaging efforts, or mitigates risk of pre-imaged computing devices remaining in inventory for some time. In doing so, the techniques described herein improve efficiency and speed of provisioning computing devices. Accordingly, the techniques described herein improve computing device imaging efficiency, inventory management efficiency, maintenance-wise efficiency, and/or speed of provisioning computing devices.

In some embodiments, the computing system 101 may communicate with at least one of the client computing entity 102 and imaging system 110 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a provisioning management computing entity 106 and one or more external computing entities 108. The provisioning management computing entity 106 and/or one or more external computing entities 108 may be individually and/or collectively configured to receive computing device provisioning requests from one or more client computing entity 102, process the computing device provisioning requests by communicating with and querying a database to determine an inventory computing device from among one or more inventory computing devices 112 based on the computing device provisioning requests, provide automated custom build instructions identifying application criteria (for custom build operations to be performed by the imaging system 110 on the inventory computing devices) from the computing device provisioning requests, and generate one or more logistical operation instructions for the inventory computing devices.

For example, as discussed in further detail herein, the provisioning management computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the provisioning management computing entity 106 and/or one or more external computing entities 108 are communicatively coupled using one or more wired and/or wireless communication techniques. The respective computing entities may be specially configured to perform one or more steps/operations of one or more techniques described herein. By way of example, the provisioning management computing entity 106 may be configured to train, implement, use, update, and evaluate machine learning models in accordance with one or more training and/or prediction operations of the present disclosure. In some examples, the external computing entities 108 may be configured to train, implement, use, update, and evaluate machine learning models in accordance with one or more training and/or prediction operations of the present disclosure.

In some example embodiments, the provisioning management computing entity 106 may be configured to receive and/or transmit one or more datasets, objects, and/or the like from and/or to the external computing entities 108 to perform one or more steps/operations of one or more techniques (e.g., inventory demand prediction techniques, pre-imaging techniques, custom build operation techniques, or provisioning techniques, and/or the like) described herein. The external computing entities 108, for example, may include and/or be associated with one or more entities that may be configured to receive, transmit, store, manage, and/or facilitate datasets, such as a dataset including a plurality of applications, disk images, inventory data objects, and/or the like. The external computing entities 108, for example, may include data sources that may provide such datasets, and/or the like to the provisioning management computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the provisioning management computing entity 106 to obtain and aggregate data for a prediction domain.

In some example embodiments, the provisioning management computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the provisioning management computing entity 106, which may leverage the trained machine learning model to perform one or more prediction steps/operations of the present disclosure. In some examples, feedback (e.g., evaluation data, ground truth data) from the use the of the machine learning model may be recorded by the provisioning management computing entity 106. In some examples, the feedback may be provided to the one or more external computing entities 108 to continuously train the machine learning model over time. In some examples, the feedback may be leveraged by the provisioning management computing entity 106 to continuously train the machine learning model over time. In this manner, the computing system 101 may perform, via one or more combinations of computing entities, one or more prediction, training, and/or any other machine learning-based techniques of the present disclosure.

In some example embodiments, the one or more inventory computing devices 112 are communicatively coupled to the imaging system 110. In some embodiments, the imaging system 110 may be configured to (i) prepare (e.g., pre-image) and maintain (e.g., update and/or patch) the one or more inventory computing devices 112, (ii) provide the computing system 101 or the provisioning management computing entity 106 with access to the one or more inventory computing devices 112 for provisioning.

### A. Example Computing Entity

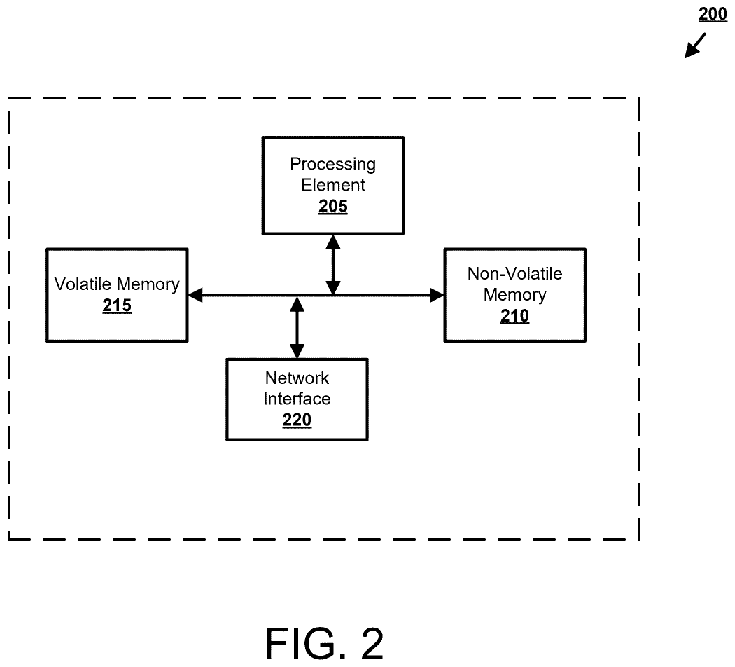

FIG. 2 provides an example computing entity 200 in accordance with some embodiments of the present disclosure. The computing entity 200 is an example of the provisioning management computing entity 106, external computing entities 108, and/or imaging system 110 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., provisioning management computing entity 106) may train and use one or more machine learning models described herein. In other embodiments, a first computing entity (e.g., provisioning management computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning model(s) described herein, and subsequently provide the trained machine learning model(s) (e.g., optimized parameters, weights, code sets) to the first computing entity over a network.

As shown in FIG. 2, in some embodiments, the computing entity 200 may include, or be in communication with, one or more processing elements 205 (also referred to as processor(s), processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. Examples of a combination of hardware and computer program products include application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In some embodiments, the computing entity 200 may further include, or be in communication with, non-transitory computer readable media, such as non-volatile media (also referred to as non-volatile storage, memory, memory storage, memory circuitry, and/or similar terms used herein interchangeably) and/or volatile media (also referred to as volatile storage, memory, memory storage, memory circuitry, and/or similar terms used herein interchangeably), as discussed above.

As will be recognized, the non-volatile media and/or the volatile media may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

Thus, the databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like may be used to control certain aspects of the operation of the computing entity 200 by operating the processing elements 205 according to software component(s) retrieved from any of the computer-readable storage media and executed by the processing element 205.

As indicated, in some embodiments, the computing entity 200 may also include one or more network interfaces 220 for communicating with various computing entities (e.g., the one or more client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as new radio (NR), general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively include, or be in communication with, one or more input elements/devices, such as input sensor(s). In some examples, the input sensor(s) may include one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively include, or be in communication with, one or more output elements/devices (not shown), such as one or more speakers, visual display devices, haptic feedback devices, motion devices (e.g., electromechanically actuated devices), and/or the like.

### B. Example Client Computing Entity or Inventory Computing Device

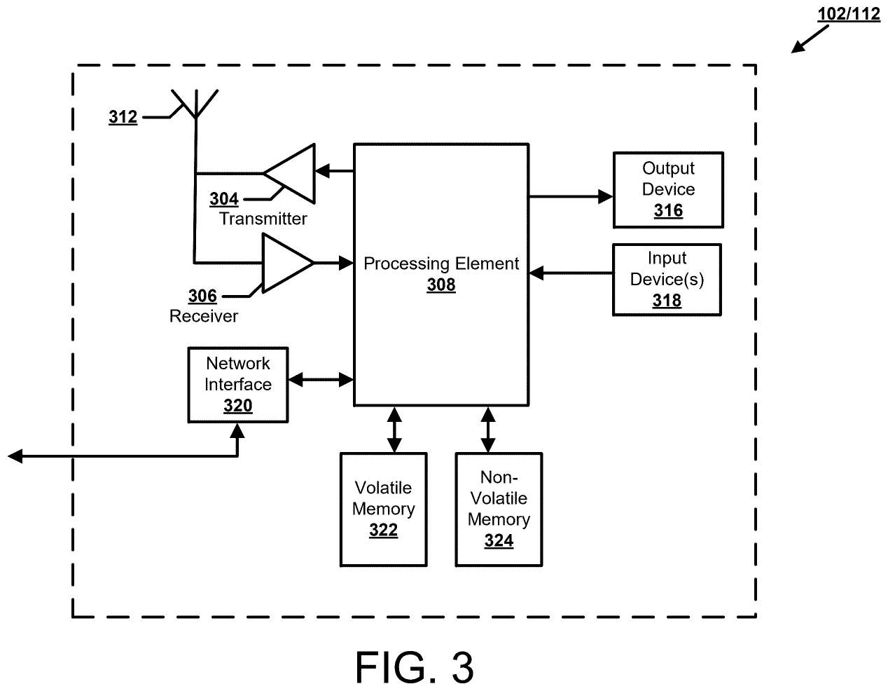

FIG. 3 provides an example client computing entity 102 or an inventory computing device 112 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., similar to or different than the output elements/devices discussed above) coupled to a processing element 308 and/or a user input device (e.g., an input sensor(s), similar to or different than the input sensor(s) discussed above) coupled to the processing element 308. In some examples, the user interface may additionally or alternatively comprise software component(s) executed by the processing element 308 to present (e.g., audibly, visually, tactilely) via an input and/or output device and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may also include volatile memory 322 and/or non-volatile memory 324, which may be embedded and/or may be removable. For example, the non-volatile memory 324 may be non-volatile media (also referred to as non-volatile storage, memory, memory storage, memory circuitry, and/or similar terms used herein interchangeably) and the volatile memory 322 may be volatile media (also referred to as volatile storage, memory, memory storage, memory circuitry, and/or similar terms used herein interchangeably), as discussed above.

The volatile memory 322 and/or non-volatile memory 324 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “image” refers to a data construct that describes a snapshot of a configured computing device. For example, an image may comprise an operating system, hardware drivers, firmware, software applications, and/or files (and/or specific versions thereof). An image may be used to deploy a pre-determined configuration and/or customized software packages across a plurality of devices within a given organization or enterprise such that certain policies may be enforced, or a consistent user experience may be ensured. An image may be deployed using various boot devices, such as booting from a USB drive or a network drive.

In some embodiments, the term “pre-imaging” refers to a process that configures a computing device with an image that comprises at least a portion of a complete configuration or a subset of customized software packages. For example, pre-imaging may be performed on a plurality of inventory computing devices that have not been specifically assigned for provisioning. According to various embodiments of the present disclosure, pre-imaging is performed on a plurality of inventory computing devices based on one or more inventory demand predictions. Inventory computing devices that have been pre-imaged may be subsequently selected in response to computing device provisioning requests for performing custom build operations that configure selected inventory computing devices with a complete configuration or a set of customized software packages for intended recipient users.

In some embodiments, the term “inventory demand prediction” refers to a data construct that describes an output of a predictive machine learning model that is configured to predict inventory demand based on deployment data (e.g., data that is associated with factors, such as age of one or more deployed computing devices or indication of deployed computing devices that are no longer under warranty), replacement indicating data (e.g., replacement necessity or hardware errors), capability requirement data (e.g., requirement for a more capable computer based on excessive CPU and/or RAM utilization), and/or provisioning trend data (e.g., provisioning rates, occurrences, or demand over time), any of which may be received from one or more computing devices that receive indication(s) of use, replacement, etc., from hardware and/or software sensor(s) deployed on provisioned computing devices and/or responsive to user input at a computing device. In some embodiments, an inventory demand prediction comprises an optimal, minimum, and/or maximum number, percentage, and/or ration of inventory computing devices and/or particular images or pre-images (e.g., software configurations) that should be maintained. In some embodiments, an inventory demand prediction also comprises one or more hardware specifications that may be desired for potential inventory computing devices requested.

In some embodiments, the term “inventory demand” refers to a data construct that describes a need for inventory computing devices. For example, inventory demand may be associated with a rate of replacement or new issuance of computing devices based on deployment data, replacement indicating data, capability requirement data, or provisioning trend data.

In some embodiments, the term “inventory computing device” refers to a computing device that is undeployed and reserved for future provisioning. For example, a plurality of inventory computing devices may be maintained as reserve or backup computing devices that may be provisioned upon demand. According to various embodiments of the present disclosure, a plurality of pre-imaged inventory computing devices is maintained by communicatively connecting the plurality of pre-imaged inventory computing devices to an imaging system that provides up-to-date images and patches to the plurality of pre-imaged inventory computing devices. In some embodiments, the plurality of pre-imaged inventory computing devices may be indexed, identified, initiated with custom build operations, located (either on a network or physically), and/or logistically handled for provisioning to recipient users.

In some embodiments, the term “inventory data object” refers to a data construct that describes an inventory computing device. An inventory data object may comprise one or more object attributes that are associated with a device identifier, hardware specification data, a network address, a physical location mapping, or a status indicator. A device identifier may comprise a unique numeric or alphanumeric code that is uniquely assigned to a computing device. Hardware specification data may comprise a description of hardware components and/or capabilities of a computing device. A network address may comprise a media access control (MAC) address, a network switch number, and/or a port number. A physical location mapping may comprise an association of the network address to an identifier of a physical location (e.g., row, aisle, section) within a storage facility, building, room, or unit that a computing device is physically located. An example of a physical location mapping may comprise an association of a device identifier to a MAC address, an association of the MAC address to a port number, and the port number to an identifier of a physical location. A status indicator may comprise a flag that is associated with an availability of a computing device for provisioning.

In some embodiments, the term “computing device provisioning request” refers to a data construct that describes a demand for one or more computing devices from a plurality of inventory computing devices. A computing device provisioning request may comprise one or more hardware specifications and application criteria. According to various embodiments of the present disclosure, an inventory computing device from a plurality of pre-imaged inventory computing devices is determined as a match to the computing device provisioning request. In some embodiments, the match of the determined inventory computing device to the computing device provisioning request is determined by (i) identifying one or more hardware admissible inventory data objects from the plurality of inventory data objects based on the one or more hardware specifications and (ii) identifying an inventory data object from the one or more hardware admissible inventory data objects based on one or more object attributes of the inventory data object. In some embodiments, identifying the inventory computing device further comprises determining that the inventory data object is associated with a hardware similarity score that achieves a similarity threshold. For example, hardware specification data of a plurality of inventory data objects that are associated with a plurality of pre-imaged inventory computing devices may be compared with one or more hardware specifications of a computing device provisioning request. Based on comparisons of the hardware specification data (that is associated with the plurality of pre-imaged inventory computing devices) and the one or more hardware specifications of the computing device provisioning request, hardware specification data that is most similar to the one or more hardware specifications of the computing device provisioning request may be determined. Moreover, in some embodiments, an automated custom build instruction identifying the application criteria from the computing device provisioning request is provided to the determined inventory computing device.

In some embodiments, the term “application criteria” refers to a data construct that describes one or more applications that are desired for one or more computing devices provisioned for a computing device provisioning request.

In some embodiments, the term “hardware specification” refers to a data construct that describes a hardware component and/or capability. For example, a computing device provisioning request may comprise one or more hardware specifications that are associated with one or more hardware components and/or capabilities desired for one or more computing devices provisioned for a computing device provisioning request.

In some embodiments, the term “custom build operation” refers to a data construct that describes a process that configures a computing device subsequent to pre-imaging of the computing device. For example, a custom build operation may be performed on an inventory computing device (e.g., matching a computing device provisioning request) to refine pre-existing configurations and/or customized software packages of the inventory computing device that were provided from pre-imaging. In some embodiments, the pre-existing configurations and/or customized software packages of an inventory computing device may be modified via a custom build operation that is based on a computing device provisioning request. That is, a custom build operation may provide, to an inventory computing device, additional configurations and/or customized software packages that satisfy one or more hardware specifications of a computing device provisioning request. According to various embodiments of the present disclosure, initiating a custom build operation comprises (i) identifying a network address on a network that is associated with an inventory computing device and (ii) generating an automated custom build instruction that initiates installation of one or more applications to the inventory computing device at the network address. In some embodiments, an automated custom build instruction that is associated with a custom build operation is provided to a networked computing device (e.g., a server) to install an individually customized collection of applications to a network address associated with a device identifier of an inventory computing device. In some embodiments, a custom build operation comprises (i) routing of the computing device provisioning request to a network address (e.g., network port) of the inventory computing device and (ii) initiating imaging or installation of one or more applications (that are associated with the application criteria) on the inventory computing device.

In some embodiments, the term “predictive machine learning model” refers to a hardware and/or software architecture having one or more parameters (e.g., coefficient(s), weight(s), bias(es), activation function(s) and/or action function type(s) in examples where the activation function and/or function type is determined as part of training, clustering centroid(s)/medoid(s) and/or partition(s)) determined as a result of training the predictive machine learning model based at least in part on training hyperparameters and/or structural hyperparameters defining the predictive machine learning model's architecture. In some examples, structural hyperparameter(s) may define component(s) of the predictive machine learning model's architecture and/or their configuration/order, such as, for example, the configuration/order specifying which output(s) of one component are provided as input to other component(s); a number, type, and/or configuration of component(s) per layer, a number of layers of the predictive machine learning model, a number of input nodes in an input layer of the predictive machine learning model, a number of output nodes of an output layer of the predictive machine learning model, component dimension (e.g., input size versus output size), temperature, and/or the like. The component(s) of the predictive machine learning model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), and/or various other component(s) (e.g., adding and/or normalization layer, pooling layer, filter). Various combinations of any these components (as defined by the structural hyperparameter(s)) may result in different types of model architectures, such as a transformer-based machine learning model (e.g., embedding model(s), generative pre-trained transformer(s) (GPT(s))), neural network(s), multi-layer perceptron(s), Kolmogorov-Arnold network(s), clustering algorithm(s), support vector machine(s), etc.

Additional or alternate hyperparameter(s) (i.e., training hyperparameter(s)) may be used as part of training the predictive machine learning model. In some examples, the training hyperparameter(s), in addition to training data and/or input data, may affect determining the parameter(s) of the predictive machine learning model. For example, using a different set of training hyperparameters to train two machine learning models that have the same architecture (i.e., the same structural hyperparameters) and using the same training data may result in the parameters of the first machine learning model differing from the parameters of the second machine learning model. Despite having the same architecture and having been trained using the same training data, such machine learning models may generate different outputs from each other, given the same input data. Accordingly, accuracy, precision, recall, and/or bias may vary between such machine learning models.

In some examples, training hyperparameter(s) may include a train-test split ratio, activation function and/or activation function type (e.g., in examples like KANs where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine learning model that are altered using the loss for a particular batch or during a particular epoch of training (e.g., some components may be “frozen,” meaning their parameters are not altered based on the loss), learning rate optimization algorithm type (e.g., gradient descent, adaptive, stochastic) used to determine an alteration to one or more parameters of one or more components of the machine learning model to reduce the loss determined by the loss function, and/or the like. In some examples, the structural hyperparameters and/or the training hyperparameters may be determined by a hyperparameter optimization algorithm or based on user input, such as a software component written by a user or generated by a machine learning model. The predictive machine learning model may include any type of model configured, trained, and/or the like to generate a prediction output for a model input. The predictive machine learning model may include one or more of any type of machine learning model including one or more supervised, unsupervised, semi-supervised, and/or reinforcement learning models. In some embodiments, the predictive machine learning model may include a single machine learning model or multiple machine learning models configured to perform one or more different stages of a prediction process.

In some embodiments, a predictive machine learning model is trained using one or more training techniques. A predictive machine learning model may be trained under supervised training using a labeled training dataset that includes a set of training inputs associated with one or more machine learning biasing attributes and a set of training outputs. In some examples, the labels may comprise partition(s), centroid(s) indicated by a user, class(es), k for use in supervised clustering algorithm training, a ground truth value, a ground truth classification, and/or the like. In an example where the predictive machine learning model is a semi-supervised machine learning model, the training data set may comprise previous input(s) to and/or previous output(s) generated by the predictive machine learning model or another machine learning model. The predictive machine learning model may be trained based at least in part on providing a first training input of the set of training inputs to the predictive machine learning model, determining an output by the predictive machine learning model, determining a difference between the output and a first training output of the set of training outputs, determining a loss by a loss function based at least in part on the difference, and altering one or more parameters of the predictive machine learning model to reduce the loss (e.g., using a loss optimization algorithm, such as gradient descent). In some examples, where the predictive machine learning model is an unsupervised machine learning model, the predictive machine learning model may be provided with unlabeled data to discover patterns and insights (e.g., unsupervised learning) without explicit guidance or instructions. Examples of machine learning algorithms for unsupervised learning include clustering algorithms, such as k-means, dimensionality reduction techniques, such as principal component analysis (PCA), Boltzmann machine learning, and autoencoders. In some examples, a training and/or learning process for a machine learning model may be iteratively repeated for up to all of the inputs of a set of training inputs, respectively. The predictive machine learning model, for example, may include a supervised regression model, a classification model, a clustering algorithm, and/or the like that is trained, using a labeled training dataset, to generate a plurality of prediction outputs based on the features (e.g., biasing attribute values and/or non-biasing attribute values) of the training data objects. The prediction outputs may include class probabilities (e.g., for categorical data, etc.), confidence probabilities, binary classifications, and/or the like.

In some embodiments, a predictive machine learning model is associated with a training dataset and a validation dataset. The training dataset may include a plurality of training data objects; a first training data object of the plurality of training data objects may include one or more attribute values and a training label. The validation dataset may include a plurality of validation data objects; a first validation data object of the plurality of training data objects may include one or more attribute values. In some examples, the validation dataset may additionally or alternatively include an unlabeled dataset or a labeled dataset. In some examples, the predictive machine learning model may be pretrained using the training dataset and once trained, may be applied to the validation dataset to generate an evaluation dataset that includes the plurality of validation data objects and a plurality of prediction outputs respectively corresponding to the plurality of validation data objects.

### IV. Overview

Various embodiments of the present disclosure make important technical contributions to provisioning of computing devices that address the speed and efficiency shortcomings of existing computer imaging and building processes. For example, some techniques of the present disclosure improve device selection and configuration with respect to pre-imaging of computing devices for anticipated provisioning. To do so, predictive machine learning models may be trained to generate predictions on inventory demand based on deployment data, replacement indicating data, capability requirement data, or provisioning trend data. By doing so, some of the techniques of the present disclosure improve the efficiency and speed of provisioning computing devices. A tradeoff may exist between provisioning efficiency and speed while considering the cost of automation, such that it is trivial to improve speed by reducing efficiency. Thus, the challenge is to improve provisioning speed without sacrificing provisioning efficiency through innovative provisioning methods.

Accordingly, some of the techniques of the present disclosure that improve provisioning efficiency without harming provisioning speed, such as the techniques described herein, enable improving provisioning speed given an improved provisioning efficiency. In doing so, some of the techniques described herein improve efficiency and speed of provisioning computing device, thus reducing the number of pre-imaging operations needed and/or re-imaging of previously pre-imaged computing devices that have not been provisioned and rendered outdated. Accordingly, some of the techniques described herein improve provisioning efficiency, maintenance-wise efficiency, and/or speed of provisioning computing devices.

Various embodiments of the present disclosure make important technological contributions to improving computing device provisioning by maintaining an inventory of computing devices that is established based on inventory demand predictions. As described herein, computing device provisioning may comprise a plurality of time consuming steps, such as device procurement, unboxing, imaging/configuring, packing, and transporting. In particular, certain steps, such as imaging or configuring of a computing device, may comprise additional complexities that complicate efforts to pre-emptively perform at least a portion of the time consuming steps.

In accordance with various embodiments of the present disclosure, a predictive machine learning model may be trained to predict inventory demand that are associated with computing devices that may be needed for provisioning. Accordingly, an optimal number of computing devices comprising one or more specific hardware specifications may be at least partially configured (e.g., pre-imaged) in advance for anticipated provisioning needs such that lead times between computing device provisioning requests and when computing devices are provided to recipient users associated with the computing device provisioning requests may be reduced. In this manner, some of the techniques of the present disclosure, improve computing device improve efficiency and speed of provisioning computing devices.

In accordance with various embodiments of the present disclosure, predictions may be generated for preparing and/or readying inventory computing devices based on potential inventory demand. By doing so, specific computing devices (e.g., comprising one or more hardware specifications) may be intelligently selected, in real time, from a variety of inventory computing devices may be at least partially configured. In this way, some of the techniques of the present disclosure may be practically applied, in real time, to improve lead times of computing device provisioning from a time of provisioning request.

Moreover, some of the techniques (e.g., the inventory demand prediction techniques, the pre-imaging techniques, the custom build operation techniques, or the provisioning techniques) of the present disclosure may be applied to improve efficiency and speed of provisioning computing devices. This, in turn, facilitates imaging of computing devices in a manner that anticipates future needs, reduces wasted pre-imaging efforts, or mitigates risk of pre-imaged computing devices remaining in inventory for some time. Accordingly, the techniques described herein improve computing device imaging efficiency, inventory management efficiency, maintenance-wise efficiency, and/or speed of provisioning computing devices. Other technical improvements and advantages may be realized by one of ordinary skill in the art.

Examples of technologically advantageous embodiments of the present disclosure include: (i) prediction machine learning techniques that leverage deployment data, replacement indicating data, capability requirement data, or provisioning trend data to generate inventory demand predictions, (ii) real-time computing device inventory management techniques for improved computing device provisioning request fulfillment, or (iii) provisioning techniques for providing customized application installation on inventory computing devices while reducing on-demand computing device configuration time, among others. Other technical improvements and advantages may be realized by one of ordinary skill in the art.

### V. Example System Operations

As indicated, various embodiments of the present disclosure make important technological contributions to improving computing device provisioning by maintaining an inventory of computing devices that is established based on inventory demand predictions. By doing so, specific computing devices (e.g., comprising one or more hardware specifications) may be intelligently selected, in real time, from a variety of inventory computing devices may be at least partially configured. In this way, some of the techniques of the present disclosure may be practically applied, in real time, to improve lead times of computing device provisioning from a time of provisioning request.

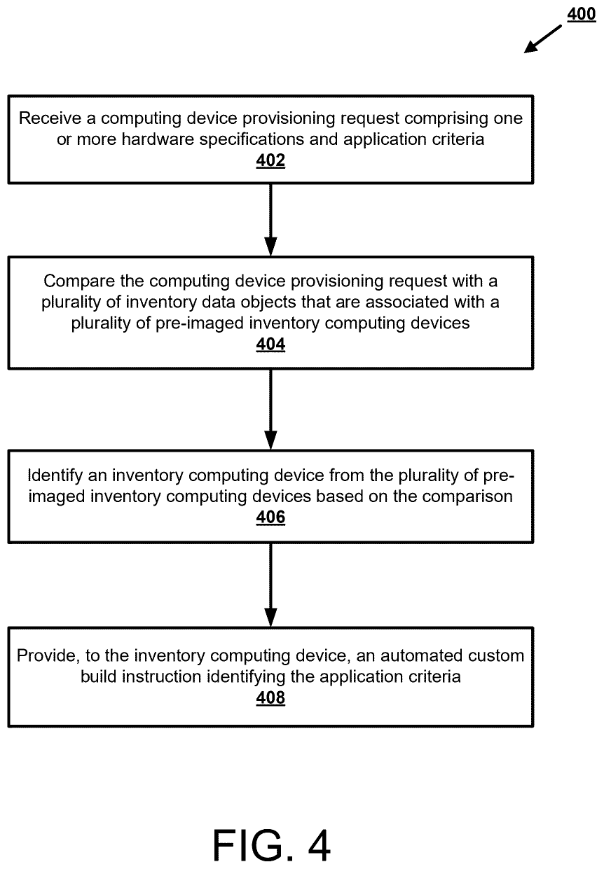

FIG. 4 is a flowchart diagram of an example process 400 for configuring inventory computing devices in accordance with some embodiments of the present disclosure.

In some embodiments, via the various steps/operations of the process 400, the computing entity 200 may determine inventory computing devices from a plurality of pre-imaged inventory computing devices that match computing device provisioning requests and initiate custom build operations on the determined inventory computing devices.

In some embodiments, the process 400 begins at step/operation 402 when the computing entity 200 receives a computing device provisioning request comprising one or more hardware specifications and application criteria. The computing device provisioning request may be received from a user (e.g., an administrator or manager) of a client computing entity, such as client computing entity 102, to indicate a request for a new computing device with a custom list of applications to install.

In some embodiments, a computing device provisioning request describes a demand for one or more computing devices from a plurality of pre-imaged inventory computing devices. According to various embodiments of the present disclosure, an inventory computing device from a plurality of pre-imaged inventory computing devices is determined as a match to the computing device provisioning request.

In some embodiments, a hardware specification describes a hardware component and/or capability. For example, a computing device provisioning request may comprise one or more hardware specifications that are associated with one or more hardware components and/or capabilities desired for one or more computing devices provisioned for a computing device provisioning request.

In some embodiments, application criteria describe one or more applications that are desired for one or more computing devices provisioned for a computing device provisioning request.

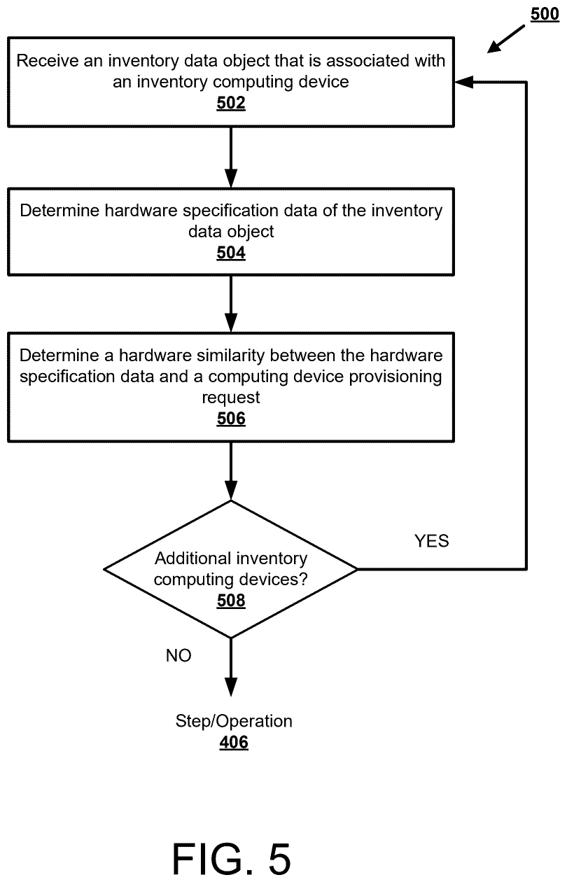

In some embodiments, at step/operation 404, the computing entity 200 compares the computing device provisioning request with a plurality of inventory data objects that are associated with a plurality of pre-imaged inventory computing devices. The computing device provisioning request may be used to query a list of inventory computing devices (e.g., inventory computing devices 112) from a database. The list of inventory computing devices may comprise a plurality of inventory data objects that are associated with a plurality of pre-imaged inventory computing devices that are maintained by the imaging system for access by the computing entity 200 to provision based on the computing device provisioning request. Comparing the computing device provisioning request with the plurality of inventory data objects are described in further detail with respect to the description of FIG. 5.

FIG. 5 is a flowchart diagram of an example process 500 for comparing a computing device provisioning request with inventory data objects in accordance with some embodiments of the present disclosure.

In some embodiments, the process 500 begins at step/operation 502 when the computing entity 200 receives an inventory data object that is associated with an inventory computing device. In some example embodiments, the inventory data object is received from a database that stores a list of inventory data objects. The inventory data object may comprise one of a plurality of inventory data objects that are associated with a plurality of pre-imaged inventory computing devices (e.g., inventory computing devices 112) that are maintained by an imaging system (e.g., imaging system 110), as described herein.

In some embodiments, an inventory data object describes an inventory computing device. An inventory data object may comprise one or more object attributes that are associated with a device identifier, hardware specification data, a network address, a physical location mapping, or a status indicator. A device identifier may comprise a unique numeric or alphanumeric code that is uniquely assigned to a computing device. Hardware specification data may comprise a description of hardware components and/or capabilities of a computing device. A network address may comprise a media access control (MAC) address, a network switch number, and/or a port number. A physical location mapping may comprise an association of the network address to an identifier of a physical location (e.g., row, aisle, section) within a storage facility, building, room, or unit that a computing device is physically located. An example of a physical location mapping may comprise an association of a device identifier to a MAC address, an association of the MAC address to a port number, and the port number to an identifier of a physical location. A status indicator may comprise a flag that is associated with an availability of a computing device for provisioning.

In some embodiments, an inventory computing device refers to a computing device that is undeployed and reserved for future provisioning. For example, a plurality of inventory computing devices may be maintained as reserve or backup computing devices that may be provisioned upon demand. According to various embodiments of the present disclosure, a plurality of pre-imaged inventory computing devices is maintained by communicatively connecting the plurality of inventory computing devices to an imaging system that provides up-to-date images and patches to the plurality of pre-imaged inventory computing devices. In some embodiments, the plurality of pre-imaged inventory computing devices may be indexed, identified, initiated with custom build operations, located (either on a network or physically), and/or logistically handled for provisioning to recipient users.

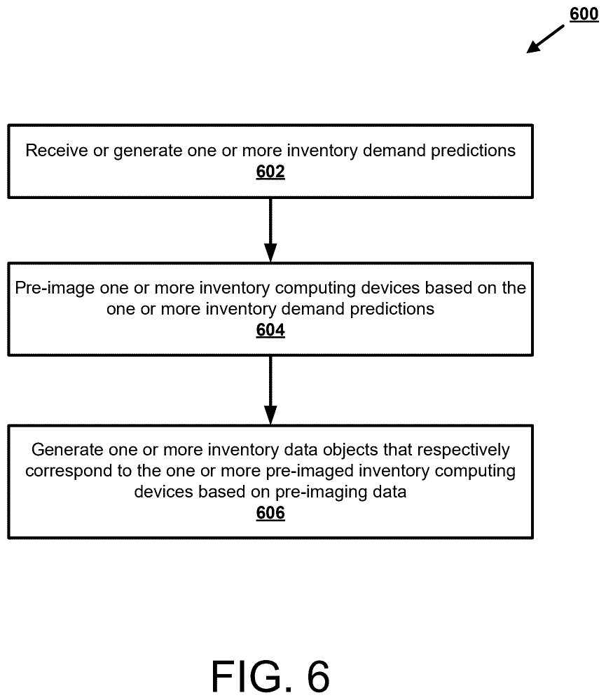

According to various embodiments of the present disclosure, the computing entity 200 may query a database for inventory data objects that are associated with a plurality of pre-imaged inventory computing devices for comparison and matching with a computing device provisioning request. In some embodiments, an imaging system may be configured to prepare (e.g., pre-image) and/or maintain (e.g., updated and/or patched) a plurality of pre-imaged inventory computing devices for provisioning based on one or more inventory demand predictions. The maintenance of a plurality of pre-imaged inventory computing devices are described in further detail with respect to the description of FIG. 6.

FIG. 6 is a flowchart diagram of an example process 600 for maintaining a plurality of pre-imaged inventory computing devices in accordance with some embodiments of the present disclosure.

In some embodiments, via the various steps/operations of the process 600, the computing entity 200 employs proactive techniques that anticipate inventory computing device needs without explicit requests.

In some embodiments, the process 600 begins at step/operation 602 when the computing entity 200 receives or generates one or more inventory demand predictions.

In some embodiments, an inventory demand prediction describes an output of a predictive machine learning model that is configured to predict inventory demand based on deployment data (e.g., data that is associated with factors, such as age of one or more deployed computing devices or indication of deployed computing devices that are no longer under warranty), replacement indicating data (e.g., replacement necessity or hardware errors), capability requirement data (e.g., requirement for a more capable computer based on excessive CPU and/or RAM utilization), and/or provisioning trend data (e.g., provisioning rates, occurrences, or demand over time), any of which may be received from one or more computing devices that receive indication(s) of use, replacement, etc., from hardware and/or software sensor(s) deployed on provisioned computing devices and/or responsive to user input at a computing device. In some embodiments, deployment data may indicate at least one of a first set of devices that were provisioned with respective custom build instructions or respective times the first set of devices were provisioned. In some embodiments, replacement data may indicate at least one of a second set of devices that were replaced or respective times the second set of devices were replaced. In some embodiments, capability requirement data may indicate at least one hardware specifications associated with at least one the first set of devices, the second set of devices, or a set of requests for new or replacement computing devices. In some embodiments, provisioning trend data may indicate one or more metrics associated with at least one of the deployment data, the replacement data, or the capability requirement data.

In some embodiments, an inventory demand prediction comprises an optimal, minimum, and/or maximum number of inventory computing devices and/or particular images or pre-images that should be configured for the inventory computing devices. In some embodiments, an inventory demand prediction also comprises one or more hardware specifications that may be desired for potential inventory computing devices requested.

In some embodiments, the predictive machine learning model is configured to process encoded representations of deployment data, replacement indicating data, capability requirement data, or provisioning trend data in order to generate inventory demand predictions. In some embodiments, the predictive machine learning model is a supervised machine learning model (e.g., a neural network model) trained using labeled data associated with one or more ground-truth inventory demand. In some embodiments, the predictive machine learning model is an unsupervised machine learning model (e.g., a clustering model), where the unsupervised machine learning model is configured to map encoded representations of the deployment data, replacement indicating data, capability requirement data, or provisioning trend data into a multi-dimensional space including mappings of encoded representations of one or more ground-truth inventory demand in order to determine a selected subset of the ground-truth inventory demand whose encoded representation mapping is deemed sufficiently close to the encoded representation mapping of the deployment data, replacement indicating data, capability requirement data, or provisioning trend data to determine inventory demand predictions.

In some embodiments, inventory demand describes a need for inventory computing devices. For example, inventory demand may be associated with a rate of replacement or new issuance of computing devices based on deployment data, replacement indicating data, capability requirement data, or provisioning trend data.

In some embodiments, at step/operation 604, the computing entity 200 pre-imaging one or more inventory computing devices based on the one or more inventory demand predictions. Pre-imaging the one or more inventory computing devices may comprise procuring, imaging, configuring, and/or readying of one or more inventory computing devices on a network via an imaging system based on one or more inventory demand predictions. As such, the imaging system may ensure readiness of a plurality of pre-imaged inventory computing devices for potential provisioning upon receipt of computing device provisioning requests by batch preparing and connecting inventory computing devices to a network. For example, one or more inventory computing devices comprising specific hardware specifications that are based on one or more inventory demand predictions may be accessible through a network, pre-configured, and made available through the network for further configuration (e.g., installation of one or more applications) and/or provisioning in response to one or more computing device provisioning requests.

In some embodiments, pre-imaging refers to a process that configures a computing device with an image that comprises at least a portion of a complete configuration or a subset of customized software packages. For example, pre-imaging may be performed on a plurality of inventory computing devices that have not been specifically assigned for provisioning. According to various embodiments of the present disclosure, pre-imaging is performed on a plurality of inventory computing devices based on one or more inventory demand predictions. Inventory computing devices that have been pre-imaged may be subsequently selected in response to computing device provisioning requests for performing custom build operations that configure selected inventory computing devices with a complete configuration or a set of customized software packages for intended recipient users.

In some embodiments, an image describes a snapshot of a configured computing device. For example, an image may comprise an operating system, hardware drivers, firmware, software applications, and/or files (and/or specific versions thereof). An image may be used to deploy a pre-determined configuration and/or customized software packages across a plurality of devices within a given organization or enterprise such that certain policies may be enforced, or a consistent user experience may be ensured. An image may be deployed using various boot devices, such as booting from a USB drive or a network drive.

Accordingly, by shifting some time-consuming tasks (e.g., associated with the prediction-based actions) upfront, such tasks may be efficiently performed in batches, strategically scheduled for optimal times, and removed from the critical path in a provisioning process. For example, anticipating higher provisioning volumes on Mondays compared to Fridays allows for preparing inventory computing devices on Fridays, optimizing bandwidth without necessitating additional resources. As such, computing device provisioning requests may progress seamlessly through to recipient user receipt in significantly reduced timeframes, measured in minutes and hours rather than days or weeks.

In some embodiments, at step/operation 606, the computing entity 200 generates one or more inventory data objects that respectively correspond to the one or more pre-imaged inventory computing devices based on pre-imaging data. The one or more inventory data objects may be used to generate a list of inventory computing devices that may be stored in a database and queried for provisioning in response to computing device provisioning requests. For example, the list of inventory computing devices may be referenced based on one or more computing device provisioning requests to access one or more inventory computing devices that are coupled to a network at specific network addresses. Accordingly, computing device provisioning requests may be triaged, matched to inventory computing devices, and used to instruct an imaging system to start application installation based on application criteria that are associated with the computing device provisioning requests.

Returning to FIG. 5, in some embodiments, at step/operation 504, the computing entity 200 determines hardware specification data of the inventory data object. The hardware specification data may be representative of hardware components and/or capabilities of the inventory computing device that is associated with the inventory data object. In some embodiments, the hardware specification data may be extracted from, for example, a data field or record from the inventory data object.

In some embodiments, at step/operation 506, the computing entity 200 determines a hardware similarity between the hardware specification data and a computing device provisioning request. According to various embodiments of the present disclosure, the computing device provisioning request comprises one or more hardware specifications that are representative of one or more desired hardware components and/or capabilities. As such, the hardware similarity may be determined by comparing the one or more hardware specifications of the computing device provisioning request with the hardware specification data of the inventory data object.

In some embodiments, determining the hardware similarity comprises identifying one or more hardware admissible inventory data objects from a plurality of inventory data objects based on the one or more hardware specifications. For example, a plurality of inventory data objects that are associated with a plurality of pre-imaged inventory computing devices may be compared with one or more hardware specifications of the computing device provisioning request. Based on comparisons of the plurality of inventory data objects and the one or more hardware specifications of the computing device provisioning request, one or more hardware admissible inventory data objects may be determined. In some embodiments, one or more hardware admissible inventory data objects are determined based on an overlap or an amount of the one or more hardware specifications (from the computing device provisioning request) found in the one or more hardware admissible inventory data objects.

In some embodiments, at step/operation 508, the computing entity 200 determines whether there are any additional inventory computing devices. In some embodiments, if there are additional inventory computing devices, the process returns to step/operation 502 where the computing entity 200 receives another inventory data object that is associated with another inventory computing device. Accordingly, steps/operations 502 through 508 may be performed until there are no additional inventory computing devices to determine a hardware similarity with the computing device provisioning request. In some embodiments, if there are no additional inventory computing devices, the computing entity 200 proceeds to step/operation 406.

Returning to FIG. 4, in some embodiments, at step/operation 406, the computing entity 200 identifies an inventory computing device from the plurality of pre-imaged inventory computing devices based on the comparison. In some embodiments, identifying the inventory computing device comprises identifying an inventory data object from the one or more hardware admissible inventory data objects based on one or more object attributes of the inventory data object. In some embodiments, identifying the inventory computing device further comprises determining that the inventory data object is associated with a hardware similarity score that achieves a similarity threshold.

In some embodiments, at step/operation 408, the computing entity 200 provides, to the inventory computing device, an automated custom build instruction identifying the application criteria. According to various embodiments of the present disclosure, the computing device provisioning request comprises application criteria that are representative of one or more applications that may be desired for the inventory computing device. As such, a custom build operation may be performed on the inventory computing device based on application criteria of the computing device provisioning request. In some embodiments, initiating a custom build operation comprises (i) identifying a network address on a network that is associated with an inventory computing device and (ii) generating an automated custom build instruction that initiates installation of one or more applications to a network address associated with a device identifier of the inventory computing device.

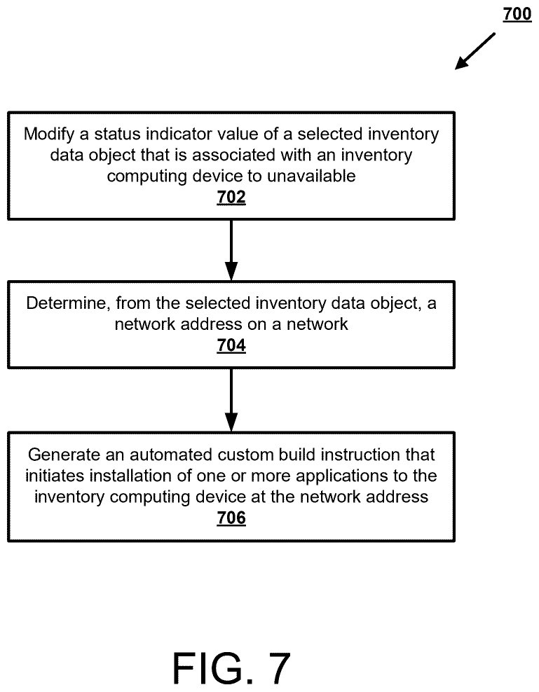

In some embodiments, a custom build operation describes a process that configures a computing device subsequent to pre-imaging of the computing device. For example, a custom build operation may be performed on an inventory computing device (e.g., matching a computing device provisioning request) to refine pre-existing configurations and/or customized software packages of the inventory computing device that were provided from pre-imaging. In some embodiments, the pre-existing configurations and/or customized software packages of an inventory computing device may be modified via a custom build operation that is based on a computing device provisioning request. That is, a custom build operation may provide, to an inventory computing device, additional configurations and/or customized software packages that satisfy one or more hardware specifications of a computing device provisioning request. In some embodiments, a custom build operation comprises (i) routing of the computing device provisioning request to a network address (e.g., network port) of the inventory computing device and (ii) initiating imaging or installation of one or more applications (that are associated with the application criteria) on the inventory computing device. Initiation of a custom build operation is described in further detail with respect to the description of FIG. 7.

FIG. 7 is a flowchart diagram of an example process 700 for initiating a custom build operation in accordance with some embodiments of the present disclosure.

In some embodiments, the process 700 begins at step/operation 702 when the computing entity 200 modifies a status indicator value of a selected inventory data object that is associated with an inventory computing device to unavailable. The status indicator value may comprise a data variable or flag that is configurable to representative an availability (e.g., available or unavailable) of the inventory computing device. For example, by modifying the status indicator value to “unavailable,” an associated inventory computing device may be omitted from consideration or queries for other or future computing device provisioning requests. As such, the inventory computing device may be provisioned for a single computing device provisioning request.

In some embodiments, at step/operation 704, the computing entity 200 determines, from the selected inventory data object, a network address on a network. According to various embodiments of the present disclosure, the inventory computing device may be coupled to a network and located at a given network address via a device identifier that is determined from the selected inventory data object.

In some embodiments, at step/operation 706, the computing entity 200 generates an automated custom build instruction that initiates installation of one or more applications to the inventory computing device at the network address. According to various embodiments of the present disclosure, the automated custom build instruction may be provided to an imaging system that is coupled the same network as the inventory computing device. Via the automated custom build instruction, the imaging system may be configured to install a customized collection of applications (e.g., based on the computing device provisioning request) to the network address matching the device identifier.

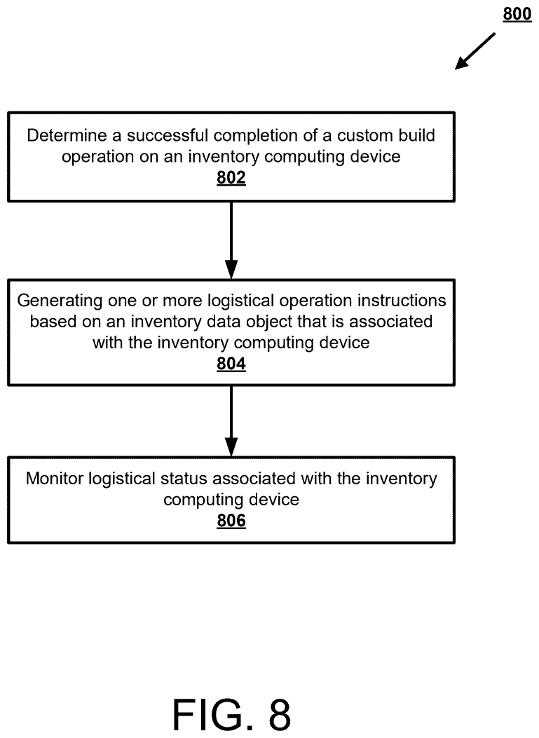

FIG. 8 is a flowchart diagram of an example process 800 for provisioning inventory computing devices in accordance with some embodiments of the present disclosure.

In some embodiments, the process 800 begins at step/operation 802 when the computing entity 200 determines a successful completion of a custom build operation on an inventory computing device. For example, a successful completion of a custom build operation may comprise completion of installation of one or more applications on an inventory computing device by an imaging system. In some example embodiments, upon detection of complete application installation(s), automation is triggered to start logistical operations for the inventory computing device.

In some embodiments, at step/operation 804, the computing entity 200 generates one or more logistical operation instructions based on an inventory data object that is associated with the inventory computing device. According to various embodiments of the present disclosure, generating the one or more logistical operation instructions comprises generating a shipment request based on a selected inventory data object that is associated with the inventory computing device. In some embodiments, the one or more logistical operations further comprises generating and printing a shipping order and label. For example, the shipping order and label may be received by a computing device retriever (e.g., via automation, robotics, machinery, or device-assisted operation) and used to retrieve the inventory computing device from a warehouse or storage location based on a physical location printed on the label, along with other parts/accessories/peripherals (also on the label) in a box for shipment. Accordingly, the inventory computing device may be shipped and delivered to recipient user.

In some embodiments, at step/operation 806, the computing entity 200 monitors logistical status associated with the inventory computing device. The logistical status may comprise a delivery and/or shipping progress of the inventory computing device to a recipient user. Upon the recipient user receiving the inventory computing device, provisioning of the inventory computing device may be completed, and a computing device provisioning request associated with the inventory computing device may be fulfilled.

According to various embodiments of the present disclosure, batch processing that optimizes computing device imaging efficiency and speed, while simultaneously ensuring on-demand computing device builds with up-to-date images and patches, are distinguishing features and improvements over conventional computing device provisioning methods. With precise knowledge of a computing device's hardware specifications and location, inefficiencies, such as selecting a wrong computing device are reduced or eliminated. Additionally, application installations may commence immediately upon an approved request, facilitated by automated shipping label printing.

The disclosed embodiments differ from conventional computing device provisioning processes, particularly when dealing with large-scale volumes. Compared to conventional computing device provisioning processes that do not perform request-based imaging and provide non-customized application builds, the disclosed processes introduce unique efficiencies that are both cost-effective and expeditious. That is, conventional computing device provisioning processes may build with applications already within the image, which at scale is not cost effective if not ever application is used by every end user. Various embodiments of the present disclosure may reduce costs from a build perspective as well as mitigate downtime for new hires or existing users facing device issues. For example, some embodiments facilitate the imaging of a computing device prior to a provisioning request is initiated, with one or more tasks related to setup, application installation, and post-build processes that are efficiently managed. Consequently, several embodiments of the present disclosure enable provisioning of fully equipped computing devices to recipient users faster than conventional computing device provisioning processes.

Accordingly, as described above, various embodiments of the present disclosure make important technical contributions to provisioning of computing devices that address the speed and efficiency shortcomings of existing computer imaging and building processes. This approach improves the efficiency and speed of provisioning computing devices. A tradeoff may exist between provisioning efficiency and speed while considering the cost of automation, such that it is trivial to improve speed by reducing efficiency. Thus, the challenge is to improve provisioning speed without sacrificing provisioning efficiency through innovative provisioning methods. Accordingly, some of the techniques of the present disclosure that improve provisioning efficiency without harming provisioning speed, such as the techniques described herein, enable improving provisioning speed given an improved provisioning efficiency. In doing so, some of the techniques described herein improve efficiency and speed of provisioning computing device, thus reducing the number of pre-imaging operations needed and/or re-imaging of previously pre-imaged computing devices that have not been provisioned and rendered outdated. Accordingly, some of the techniques described herein improve provisioning efficiency, maintenance-wise efficiency, and/or speed of provisioning computing devices.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” or the like means that a particular element, feature, structure, or characteristic described in connection with the embodiment is included in at least one embodiment, but not every embodiment necessarily includes the particular element, feature, structure, or characteristic. Different instances of the phrase “in one embodiment” in various places in the specification do not necessarily all refer to the same embodiment, although they may in some cases.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element. ” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations.

In some examples, any machine-learned model discussed herein could be one or multiple ML models, such as a pipeline, agentic framework, and/or the like.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: receiving, by one or more processors, pre-imaging data for a plurality of pre-imaged computing devices; generating, by the one or more processors and using the pre-imaging data, a plurality of data objects that respectively correspond to the plurality of pre-imaged computing devices, wherein a first data object of the plurality of data objects comprises a data construct that describes a first computing device of the plurality of pre-imaged computing devices; receiving, by the one or more processors, a computing device provisioning request comprising one or more hardware specifications and application criteria; determining, by the one or more processors, a computing device from the plurality of pre-imaged computing devices based at least in part on the one or more hardware specifications and the plurality of data objects; generating, by the one or more processors, a custom build instruction identifying the application criteria; and transmitting, by the one or more processors, the custom build instruction to the computing device.

Example 2. The computer-implemented method of example 1, wherein the plurality of pre-imaged computing devices is pre-imaged based at least in part on a plurality of demand predictions respectively and the computer-implemented method further comprises: receiving at least one of: deployment data indicating at least one of a first set of devices that were provisioned with respective custom build instructions or respective times the first set of devices were provisioned; replacement data indicating at least one of a second set of devices that were replaced or respective times the second set of devices were replaced; capability requirement data indicating at least one hardware specifications associated with at least one the first set of devices, the second set of devices, or a set of requests for new or replacement computing devices; or provisioning trend data indicating one or more metrics associated with at least one of the deployment data, the replacement data, or the capability requirement data; and generating, by a machine learning model using at least one of the deployment data, the replacement data, the capability requirement data, or the provisioning trend data, one or more demand predictions of the plurality of demand predictions indicating a target number or percentage of at least one of hardware configurations or software configurations with respect to the plurality of pre-imaged computing devices.

Example 3. The computer-implemented method of example 2, further comprising determining, using the one or more demand predictions, the pre-imaging data.

Example 4. The computer-implemented method of example 1, wherein providing the custom build instruction further comprises: determining a network address that is associated with the computing device; and generating the custom build instruction that initiates installation of one or more applications that are associated with the application criteria to the computing device at the network address.

Example 5. The computer-implemented method of example 1 further comprising: identifying a first subset of data objects from the plurality of data objects based at least in part on the one or more hardware specifications, wherein determining the computing device from the plurality of pre-imaged computing devices comprises determining a data object from the first subset of data objects using the one or more hardware specifications and one or more object attributes of the data object.

Example 6. The computer-implemented method of example 5, wherein determining the data object from the first subset of data objects comprises: determining, using the one or more hardware specifications and data indicated by the data object, a hardware similarity score; and determining that the hardware similarity score meets or exceeds a similarity threshold.

Example 7. The computer-implemented method of example 1 further comprising generating one or more logistical operation instructions for the computing device.

Example 8. The computer-implemented method of example 7, wherein generating the one or more logistical operation instructions comprises at least one of: generating a shipment request based at least in part on a determined data object that is associated with the computing device from the plurality of data objects; or transmitting an instruction to one or more computing devices to cause a machine to at least one of remove the computing device from physical storage, store the computing device in a physical container, affix a shipping label to the physical container, or deliver the physical container to a location.

Example 9. A system comprising one or more processors; and at least one memory storing processor-executable instructions that, when collectively or independently executed by any one or more of the one or more processors, comprise causing the one or more processors to: receive pre-imaging data for a pre-imaged computing device; generate, using the pre-imaging data, a data object for the pre-imaged computing device; receive a computing device provisioning request comprising one or more hardware specifications and application criteria; determine the pre-imaged computing device from a plurality of pre-imaged computing devices based at least in part on the one or more hardware specifications and a plurality of data objects; generate a custom build instruction identifying the application criteria; and transmit the custom build instruction to the pre-imaged computing device.

Example 10. The system of example 9, wherein the pre-imaged computing device is pre-imaged based at least in part on a demand prediction and the one or more processors are further configured to generate, by a machine learning model using at least one of deployment data, replacement data, capability requirement data, or provisioning trend data, the demand prediction.

Example 11. The system of example 10, wherein the one or more processors are further configured to determine, using the demand prediction, the pre-imaging data.

Example 12. The system of example 9, wherein to provide the custom build instruction, the one or more processors are further configured to: determine a network address that is associated with the pre-imaged computing device; and generate the custom build instruction that initiates installation of one or more applications that are associated with the application criteria to the pre-imaged computing device at the network address.

Example 13. The system of example 9, wherein the one or more processors are further configured to: identify a first subset of data objects from the plurality of data objects based at least in part on the one or more hardware specifications, wherein to determine the pre-imaged computing device from the plurality of pre-imaged computing devices, the one or more processors are further configured to determine the data object from the first subset of data objects using the one or more hardware specifications and one or more object attributes of the data object.

Example 14. The system of example 13, wherein to determine the data object from the first subset of data objects, the one or more processors are further configured to: determine, using the one or more hardware specifications and data indicated by the data object, a hardware similarity score; and determine that the hardware similarity score meets or exceeds a similarity threshold.

Example 15. The system of example 9, wherein the one or more processors are further configured to generate one or more logistical operation instructions for the pre-imaged computing device.

Example 16. The system of example 15, wherein to generate the one or more logistical operation instructions, the one or more processors are further configured to: generate a shipment request based at least in part on a determined data object that is associated with the pre-imaged computing device from the plurality of data objects; or transmit an instruction to one or more computing devices to cause a machine to at least one of remove the pre-imaged computing device from physical storage, store the pre-imaged computing device in a physical container, affix a shipping label to the physical container, or deliver the physical container to a location.

Example 17. One or more non-transitory computer-readable storage media including instructions that, when executed by one or more processors, cause the one or more processors to: receive pre-imaging data for a pre-imaged computing device; generate, using the pre-imaging data, a data object for the pre-imaged computing device; receive a computing device provisioning request comprising one or more hardware specifications and application criteria; determine the pre-imaged computing device from a plurality of pre-imaged computing devices based at least in part on the one or more hardware specifications and a plurality of data objects; generate a custom build instruction identifying the application criteria; and transmit the custom build instruction to the pre-imaged computing device.

Example 18. The one or more non-transitory computer-readable storage media of example 17, wherein the pre-imaged computing device is pre-imaged based at least in part on a demand prediction, and further including instructions that, when executed by the one or more processors, cause the one or more processors to: generate, by a machine learning model using at least one of deployment data, replacement data, capability requirement data, or provisioning trend data, the demand prediction; and determine, using the demand prediction, the pre-imaging data.

Example 19. The one or more non-transitory computer-readable storage media of example 17 further including instructions that, when executed by the one or more processors, cause the one or more processors to: determine a network address that is associated with the pre-imaged computing device; and generate the custom build instruction that initiates installation of one or more applications that are associated with the application criteria to the pre-imaged computing device at the network address.

Example 20. The one or more non-transitory computer-readable storage media of example 17 further including instructions that, when executed by the one or more processors, cause the one or more processors to: identify a first subset of data objects from the plurality of data objects based at least in part on the one or more hardware specifications, wherein to determine the pre-imaged computing device from the plurality of pre-imaged computing devices, the one or more processors are further configured to determine the data object from the first subset of data objects using the one or more hardware specifications and one or more object attributes of the data object.

1. A computer-implemented method comprising:
receiving, by one or more processors, pre-imaging data for a plurality of pre-imaged computing devices;
generating, by the one or more processors and using the pre-imaging data, a plurality of data objects that respectively correspond to the plurality of pre-imaged computing devices, wherein a first data object of the plurality of data objects comprises a data construct that describes a first computing device of the plurality of pre-imaged computing devices;
receiving, by the one or more processors, a computing device provisioning request comprising one or more hardware specifications and application criteria;
determining, by the one or more processors, a computing device from the plurality of pre-imaged computing devices based at least in part on the one or more hardware specifications and the plurality of data objects;
generating, by the one or more processors, a custom build instruction identifying the application criteria; and
transmitting, by the one or more processors, the custom build instruction to the computing device.

2. The computer-implemented method of claim 1, wherein the plurality of pre-imaged computing devices is pre-imaged based at least in part on a plurality of demand predictions respectively and the computer-implemented method further comprises:
receiving at least one of:
deployment data indicating at least one of a first set of devices that were provisioned with respective custom build instructions or respective times the first set of devices were provisioned;
replacement data indicating at least one of a second set of devices that were replaced or respective times the second set of devices were replaced;
capability requirement data indicating at least one hardware specifications associated with at least one the first set of devices, the second set of devices, or a set of requests for new or replacement computing devices; or
provisioning trend data indicating one or more metrics associated with at least one of the deployment data, the replacement data, or the capability requirement data; and
generating, by a machine learning model using at least one of the deployment data, the replacement data, the capability requirement data, or the provisioning trend data, one or more demand predictions of the plurality of demand predictions indicating a target number or percentage of at least one of hardware configurations or software configurations with respect to the plurality of pre-imaged computing devices.

3. The computer-implemented method of claim 2, further comprising determining, using the one or more demand predictions, the pre-imaging data.

4. The computer-implemented method of claim 1, wherein providing the custom build instruction further comprises:
determining a network address that is associated with the computing device; and
generating the custom build instruction that initiates installation of one or more applications that are associated with the application criteria to the computing device at the network address.

5. The computer-implemented method of claim 1 further comprising:
identifying a first subset of data objects from the plurality of data objects based at least in part on the one or more hardware specifications,
wherein determining the computing device from the plurality of pre-imaged computing devices comprises determining a data object from the first subset of data objects using the one or more hardware specifications and one or more object attributes of the data object.

6. The computer-implemented method of claim 5, wherein determining the data object from the first subset of data objects comprises:
determining, using the one or more hardware specifications and data indicated by the data object, a hardware similarity score; and
determining that the hardware similarity score meets or exceeds a similarity threshold.

7. The computer-implemented method of claim 1 further comprising generating one or more logistical operation instructions for the computing device.

8. The computer-implemented method of claim 7, wherein generating the one or more logistical operation instructions comprises at least one of:
generating a shipment request based at least in part on a determined data object that is associated with the computing device from the plurality of data objects; or
transmitting an instruction to one or more computing devices to cause a machine to at least one of remove the computing device from physical storage, store the computing device in a physical container, affix a shipping label to the physical container, or deliver the physical container to a location.

9. A system comprising
one or more processors; and
at least one memory storing processor-executable instructions that, when collectively or independently executed by any one or more of the one or more processors, comprise causing the one or more processors to:
receive pre-imaging data for a pre-imaged computing device;
generate, using the pre-imaging data, a data object for the pre-imaged computing device;
receive a computing device provisioning request comprising one or more hardware specifications and application criteria;
determine the pre-imaged computing device from a plurality of pre-imaged computing devices based at least in part on the one or more hardware specifications and a plurality of data objects;
generate a custom build instruction identifying the application criteria; and
transmit the custom build instruction to the pre-imaged computing device.

10. The system of claim 9, wherein the pre-imaged computing device is pre-imaged based at least in part on a demand prediction and the one or more processors are further configured to generate, by a machine learning model using at least one of deployment data, replacement data, capability requirement data, or provisioning trend data, the demand prediction.

11. The system of claim 10, wherein the one or more processors are further configured to determine, using the demand prediction, the pre-imaging data.

12. The system of claim 9, wherein to provide the custom build instruction, the one or more processors are further configured to:
determine a network address that is associated with the pre-imaged computing device; and
generate the custom build instruction that initiates installation of one or more applications that are associated with the application criteria to the pre-imaged computing device at the network address.

13. The system of claim 9, wherein the one or more processors are further configured to:
identify a first subset of data objects from the plurality of data objects based at least in part on the one or more hardware specifications,
wherein to determine the pre-imaged computing device from the plurality of pre-imaged computing devices, the one or more processors are further configured to determine the data object from the first subset of data objects using the one or more hardware specifications and one or more object attributes of the data object.

14. The system of claim 13, wherein to determine the data object from the first subset of data objects, the one or more processors are further configured to:
determine, using the one or more hardware specifications and data indicated by the data object, a hardware similarity score; and
determine that the hardware similarity score meets or exceeds a similarity threshold.

15. The system of claim 9, wherein the one or more processors are further configured to generate one or more logistical operation instructions for the pre-imaged computing device.

16. The system of claim 15, wherein to generate the one or more logistical operation instructions, the one or more processors are further configured to:
generate a shipment request based at least in part on a determined data object that is associated with the pre-imaged computing device from the plurality of data objects; or
transmit an instruction to one or more computing devices to cause a machine to at least one of remove the pre-imaged computing device from physical storage, store the pre-imaged computing device in a physical container, affix a shipping label to the physical container, or deliver the physical container to a location.

17. One or more non-transitory computer-readable storage media including instructions that, when executed by one or more processors, cause the one or more processors to:
receive pre-imaging data for a pre-imaged computing device;
generate, using the pre-imaging data, a data object for the pre-imaged computing device;
receive a computing device provisioning request comprising one or more hardware specifications and application criteria;
determine the pre-imaged computing device from a plurality of pre-imaged computing devices based at least in part on the one or more hardware specifications and a plurality of data objects;
generate a custom build instruction identifying the application criteria; and
transmit the custom build instruction to the pre-imaged computing device.

18. The one or more non-transitory computer-readable storage media of claim 17, wherein the pre-imaged computing device is pre-imaged based at least in part on a demand prediction, and further including instructions that, when executed by the one or more processors, cause the one or more processors to:
generate, by a machine learning model using at least one of deployment data, replacement data, capability requirement data, or provisioning trend data, the demand prediction; and
determine, using the demand prediction, the pre-imaging data.

19. The one or more non-transitory computer-readable storage media of claim 17 further including instructions that, when executed by the one or more processors, cause the one or more processors to:
determine a network address that is associated with the pre-imaged computing device; and
generate the custom build instruction that initiates installation of one or more applications that are associated with the application criteria to the pre-imaged computing device at the network address.

20. The one or more non-transitory computer-readable storage media of claim 17 further including instructions that, when executed by the one or more processors, cause the one or more processors to:
identify a first subset of data objects from the plurality of data objects based at least in part on the one or more hardware specifications,
wherein to determine the pre-imaged computing device from the plurality of pre-imaged computing devices, the one or more processors are further configured to determine the data object from the first subset of data objects using the one or more hardware specifications and one or more object attributes of the data object.
